(19) United States
(12) Patent Application Publication
(10) Pub. No.: US 2025/0025853 A1
(43) Pub. Date: Jan. 23, 2025

(54) APPARATUS FOR MANUFACTURING POLYOLEFIN

(71) Applicants: SK INNOVATION CO., LTD., Seoul (KR); SK GEO CENTRIC CO., LTD., Seoul (KR)

(72) Inventors: Dae Hak KIM, Daejeon (KR); Gil Su KWAK, Daejeon (KR); Sung Jae NA, Daejeon (KR); Sang Young SHIN, Daejeon (KR)

(21) Appl. No.: 18/714,571

(22) PCT Filed: Dec. 1, 2022
(86) PCT No.: PCT/KR2022/019373

§ 371 Date: May 30, 2024

(30) Foreign Application Priority Data
Dec. 3, 2021 (KR) 10-2021-0172173

(51) Int. Cl. B01J 19/24; B01J 19/06; C08F 10/02; C08F 10/06

(52) U.S. Cl. CPC B01J 19/2465; B01J 19/06; C08F 10/02; C08F 10/06

(57) ABSTRACT

The present invention provides an apparatus for manufacturing a polyolefin comprising a single gas phase reactor. The apparatus for manufacturing a polyolefin according to exemplary embodiments is an apparatus for producing a prepolymer or a polymer by continuously polymerizing an olefin monomer, and includes: a loop reactor including a first reaction space; and a single gas phase reactor including a second reaction space into which a first product produced in the loop reactor is introduced, wherein the volume ratio of the second reaction space to the first reaction space is adjusted to 1.2 or more. Therefore, it is possible to prepare a polyolefin including high content ethylene-propylene rubber such as impact polypropylene, only by the configuration of a single gas phase reactor without having a plurality of gas phase reactors.

### TECHNICAL FIELD

The present invention relates to an apparatus for manufacturing a polyolefin, and more particularly, to an apparatus for manufacturing a polyolefin, which includes a single gas phase REACTOR.

### BACKGROUND ART

As a polymerization method of olefins for producing various types of polyolefins such as polyolefin copolymers including polyethylene, polypropylene, and the like, a method of forming a polymerization slurry of a solid polymer and a liquid monomer, and polymerizing the polyolefin using a gas phase reactor is known in the art. Unipole process using two gas-phase fluidized bed reactors is more economically feasible than other polyolefin polymerization methods, and a slurry polymerization method using a monomer such as propylene as a polymerization medium may maximize a rate of polymerization reaction by providing high concentration monomers.

Meanwhile, molecular weight (MW) and molecular weight distribution (MWD) affect physical and mechanical properties of polyolefin, as well as applications thereof. The higher the molecular weight, the higher the mechanical properties of the polyolefin, but the lower the fluidity, such that difficulties arise in the manufacturing process.

In order to improve the mechanical and physical properties of the polyolefin produced in the gas phase reactor, a multi-stage polymerization method, in which a plurality of slurry polymerization reactors and gas phase reactors are continuously connected, is used. In a process including a loop reactor and a gas phase reactor (GPR), in order to produce reactor-made thermoplastic polyolefin (rTPO) products containing 30% or more of ethylene-propylene rubber (EPR), a Double GPR system, in which at least two gas phase reactors are connected, is required.

In this regard, European Patent Registration EP 0503791 B1 discloses a process for manufacturing a polymer having a relatively high molecular weight by Double GPRS which are connected in series. However, due to differences in the molecular weight, chemical composition and crystallinity in the respective reactors of the series-connected process, the homogeneity of the finally produced polymer is deteriorated. In addition, in the case of the Double GPR system, there are problems in that frequent inspections are required due to trouble caused by valves during transferring particles, and additional facilities such as a recycle compressor, a gas separation/recovery facility and a particle transfer facility are required, as compared to the single gas phase reactor (Single GPR) system.

### DISCLOSURE

### Technical Problem

It is an object of the present invention to provide an apparatus for manufacturing a polyolefin with improved process efficiency and stability, which may produce a thermoplastic polyolefin including ethylene-propylene rubber in a high content while including a single gas phase reactor.

### Technical Solution

To achieve the above object, according to an aspect of the present invention, there is provided an apparatus for manufacturing a polyolefin, which is an apparatus for producing a prepolymer or a polymer by continuously polymerizing an olefin monomer, and includes: a loop reactor including a first reaction space; and a single gas phase reactor including a second reaction space into which a first product produced in the loop reactor is introduced.

In some embodiments, a volume ratio of the second reaction space to the first reaction space may be 1.2 or more.

In some embodiments, the loop reactor may produce a first product from a slurry including a liquid olefin monomer and a polyolefin in the first reaction space.

In some embodiments, the loop reactor may be a plurality of loop reactors which are connected in series.

In some embodiments, an operating temperature of the loop reactor may be 50 to 100° C.

In some embodiments, an operating pressure of the loop reactor may be 10 to 100 bar.

In some embodiments, the loop reactor may be operated in a hydrogen (H₂) atmosphere at a concentration of 300 to 40,000 ppmv.

In some embodiments, the single gas phase reactor may form a polyolefin including ethylene-propylene rubber in the second reaction space.

In some embodiments, an operating temperature of the single gas phase reactor may be 50 to 100° C.

In some embodiments, an operating pressure of the single gas phase reactor may be 1 to 60 bar.

In some embodiments, the polyolefin may have an ethylene-propylene rubber (EPR) content of 30% or more.

In some embodiments, the polyolefin may be impact polypropylene (impact PP).

### Advantageous Effects

The apparatus for manufacturing a polyolefin according to exemplary embodiments is an apparatus for producing a prepolymer or a polymer by continuously polymerizing an olefin monomer, and includes: a loop reactor including a first reaction space; and a single gas phase reactor including a second reaction space into which a first product produced in the loop reactor is introduced, wherein the volume ratio of the second reaction space to the first reaction space is adjusted to 1.2 or more. Therefore, it is possible to prepare a polyolefin including high content ethylene-propylene rubber such as impact polypropylene, only by the configuration of a single gas phase reactor without having a plurality of gas phase reactors.

In addition, since the apparatus for manufacturing a polyolefin is configured as a single gas phase reactor, there is no need to provide additional facilities such as circulation compressor, a gas separation/recovery facility and a particle transfer facility, thereby process efficiency and stability may be improved.

### DESCRIPTION OF DRAWINGS

FIG. 1 is a schematic view of an apparatus for manufacturing a polyolefin (‘polyolefin manufacturing apparatus’) according to an exemplary embodiment.

FIG. 2 is a schematic view of a polyolefin

manufacturing apparatus according to another exemplary embodiment.

### MODE FOR INVENTION

In descriptions of the embodiments of the present invention, publicly known techniques that are judged to be able to make the purport of the present invention unnecessarily obscure will not be described in detail. Referring to the drawings, wherein like reference characters designate like or corresponding parts throughout the several views. In addition, the terms as used herein are defined by taking functions of the present invention into account and can be changed according to the custom or intention of users or operators. Therefore, definition of the terms should be made according to the overall disclosure set forth herein.

It should be understood that the technical spirit and scope of the present invention are defined by the appended claims, and the following embodiments are only made to efficiently describe the present invention to persons having common knowledge in the technical field to which the present invention pertains.

Hereinafter, specific embodiments of the present invention will be described with reference to the accompanying drawings. However, these are merely illustrative examples and the present invention is not limited thereto.

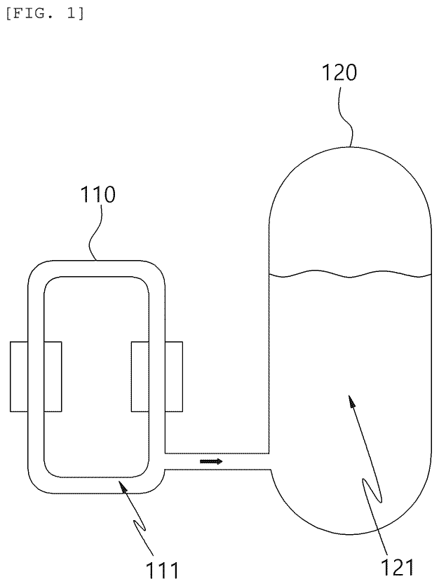

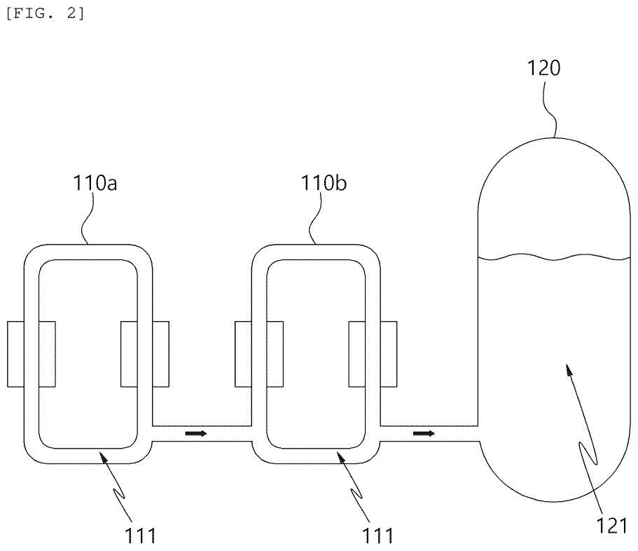

FIG. 1 is a schematic view of a polyolefin manufacturing apparatus according to an exemplary embodiment. FIG. 2 is a schematic view of a polyolefin manufacturing apparatus according to another exemplary embodiment.

Referring to FIGS. 1 and 2, a polyolefin manufacturing apparatus 100 according to an exemplary embodiment may include a loop reactor 110 including a first reaction space 111, and a single gas phase reactor 120 including a second reaction space 121.

The polyolefin manufacturing apparatus 100 refers to an apparatus configured to supply one or more of olefin monomers to the polyolefin manufacturing apparatus 100, and recover the polyolefin produced through polymerization.

The olefin monomer may be ethylene or propylene, but it is not limited thereto, and other olefin monomers may also be used. Other olefin monomers may include, for example, olefins having 4 to 8 carbon atoms. Accordingly, it is possible to prepare a homopolymer of ethylene or propylene or a copolymer of ethylene and/or propylene with one or more alpha olefin monomers consisting of 4 to 8 carbons. Preferred olefin monomers include, without limitation thereof, but-1-ene, isobutene, pent-1-ene, hex-1-ene, hexadiene, isoprene, styrene, 4-methylpent-1-ene, oct-1-ene and butadiene.

When using the polyolefin manufacturing apparatus 100 according to the exemplary embodiment for copolymerization of an olefin monomer with ethylene and/or propylene, it is preferable to use ethylene and/or propylene as a main ingredient of the copolymer.

The loop reactor 110 is a pipe-type reactor in which the first reaction space 111 is arranged in a loop shape. In order to facilitate heat transfer required for the reaction and shorten the residence time of reactants, it is preferable that the loop reactor 110 has a high volume ratio compared to the surface area. The loop reactor 110 may be disposed so that a plurality of loop reactors 110a and 110b are connected in series.

The loop reactor 110 may use a prepolymer in the first reaction space 111 to form a slurry including a liquid olefin monomer and a polyolefin, then a homopolymer consisting of homo-olefin monomer units is formed from the slurry.

The prepolymer may be produced by polymerizing a mixture of an external electron donor and an olefin with a catalyst and/or a cocatalyst in a separate prepolymerization reactor, and may be solid polymer particles having a polymer attached to the surface of the catalyst.

The catalyst may be any catalyst capable of manufacturing the desired polyolefin polymer. For example, the catalyst may be, in particular, Ziegler-Natta catalysts based on transition metals such as titanium, zirconium and/or vanadium catalysts, but it is not limited thereto.

The cocatalyst activates the catalyst and allows the catalyst to maintain high activity. The cocatalyst may be a metal alkyl compound, but it is not limited thereto, and may be, for example, ethylaluminum dichloride, diethylaluminum chloride, ethylaluminum sesquichloride, dimethylaluminum chloride, trimethylaluminum, triethylaluminum, triisobutylaluminum, trihexylaluminum, tri-n-octylaluminum, methylaluminoxane (MAO), hexaisobutylaluminoxane (HIBAO), tetraisobutyl aluminoxane (TIBAO), isoprenylaluminum.

The external electron donor is an electron donor compound used as a reactant in polyolefin polymerization. The external electron donor contains at least one functional group capable of donating at least one pair of electrons to a metal atom, and may have an effect on stereoselectivity, hydrogen sensitivity, ethylene sensitivity, randomness of comonomer incorporation and catalyst productivity of a catalyst system in polyolefin polymerization. The external electron donor may be an electron donor consisting of, for example, an organosilane compound containing Si—OCOR, Si—OR and/or Si—NR bonds having silicon as a central atom and alkyl, alkenyl, aryl, arylalkyl or cycloalkyl having 1 to 20 carbon atoms represented by R.

Meanwhile, the prepolymer may be introduced into the loop reactor 110 through an appropriate means such as a pump in the form of a liquid phase/liquid stream.

An operating temperature of the loop reactor 110 may be 50to 100° C., preferably 55 to 95° C., and more preferably 60 to 90° C. In the above operating temperature range, it is possible to suppress overheating, softening and aggregation of particles, as well as induce an appropriate polymerization reaction to the homopolymer.

An operating pressure of the loop reactor 110 may be 10 to 100 bar, preferably 20 to 80 bar, and more preferably 30 to 60 bar. In order to properly maintain a density of the homopolymer to be prepared, it is preferable to maintain the operating pressure within the above range.

The loop reactor 110 may be operated in a hydrogen (H₂) atmosphere at a concentration of 300 to 40,000 ppmv in order to control the molecular weight of the homopolymer, preferably in a hydrogen (H₂) atmosphere at a concentration of 400 to 35,000 ppmv, and more preferably in a hydrogen (H) atmosphere at a concentration of 500 to 30,000 ppmv. When increasing the concentration of hydrogen, a melt flow index (MFI) of the produced homopolymer may be increased, and if decreasing the concentration of hydrogen, the melt flow index of the homopolymer may be decreased.

the melt flow index of the

The single gas phase reactor 120 is a reactor which receives a reaction gas mixture from a lower portion of the gas phase reactor 120, removes the gas from an upper portion again, and performs a polymerization reaction in an internal space maintained in a fluidized state, and may receive the homopolymer formed in the loop reactor 110 through an appropriate means, and perform a gas phase reaction to form a polyolefin.

The polyolefin obtained from the single gas phase reactor 120 may be a random copolymer, a block copolymer or an impact copolymer, wherein the impact copolymer may contain an intimate mixture of polyolefin and polyolefin rubber. For example, an impact copolymer including polyolefin rubber may be formed. Examples of the polyolefin rubber may include ethylene-propylene rubber (EPR) and terpolymer rubber of ethylene-propylene-diene monomer (EPDM).

In particular, the single gas phase reactor 120 may form a polyolefin including ethylene-propylene rubber by forming ethylene-propylene rubber inside the homopolymer, and the formed polyolefin may contain 30% or more of ethylene-propylene rubber (EPR). Polyolefin containing 30% or more of ethylene-propylene rubber (EPR) may have remarkably enhanced impact strength by the ethylene-propylene rubber. The ethylene-propylene rubber having rubber-like properties may be present with being phase-separated in the polyolefin matrix of rigid phase.

In addition, the polyolefin may be impact polypropylene (impact PP). The impact polypropylene consists of ethylene-propylene rubber (EPR) and polypropylene homopolymer, which is a polymer polymerized to compensate for the weakness of brittle polypropylene homopolymer having a low impact strength.

The operating temperature of the single gas phase reactor 120 may be 50 to 100° C., preferably 55 to 95° C., and more preferably 60 to 90° C. The operating pressure of the single gas phase reactor 120 may be 1 to 60 bar, preferably 3 to 50 bar, and more preferably 5 to 40 bar. In order to form a polyolefin containing high content ethylene-propylene rubber, it is preferable to maintain the operating temperature and operating pressure within the above ranges.

The gas phase reactor 120 may be operated at a gas phase reactor level (GPR level) of about 30 to 70%. The gas phase reactor level (GPR level) refers to a height of a polymer particle bed staying inside the gas phase reactor 120 with respect to the height of the gas phase reactor 120. If the gas phase reactor level is less than about 30%, it may be difficult to form a stable fluidized bed, and if it exceeds about 70%, the risk of some particles being carried over to the upper portion of the reactor by gas may be increased.

In an exemplary embodiment, a volume ratio of the second reaction space 121 to the first reaction space 111 may be 1.2 or more. If the volume ratio is less than 1.2, there is a problem in that the content of the ethylene-propylene rubber included in the polyolefin is less than 30%. When the volume ratio of the second reaction space 121 to the first reaction space 111 is 1.2or more, the content of ethylene-propylene rubber included in the polyolefin may be 30% or more, such that the desired effect may be achieved. Therefore, an upper limit of the volume ratio is not particularly limited. In some exemplary embodiments, in consideration of polymer uniformity or process efficiency, the upper limit of the volume ratio may be 5.0, or in some exemplary embodiments, the upper limit of the volume ratio may be 3.0, but it is not limited thereto.

### EXAMPLES AND COMPARATIVE EXAMPLES

Ethylene, propane diluent and hydrogen were continuously put into a premixing tank together with a catalyst, and mixed for a predetermined time, then propylene was introduced into a prepolymerization reactor to form a prepolymer.

The formed prepolymer was introduced into a loop reactor, and a slurry reaction was performed with liquid propylene in a hydrogen atmosphere to form a homopolymer. In this case, the operating temperature and the operating pressure of the loop reactor were set to be 80° C. and 40 bar, respectively, and the concentration of hydrogen was set to be 10,000 ppmv.

The formed homopolymer was introduced into a gas phase reactor, and a gas phase reaction was performed in ethylene, propylene and hydrogen atmospheres to prepare a polyolefin. In this case, the operating temperature and the operating pressure of the gas phase reactor were set to be 80° C. and 10 bar, respectively, and the gas phase reactor level (GPR level) was set to be about 65%.

Conditions of the loop reactor and the gas phase reactor used in the examples and comparative examples are shown in Table 1 below.

TABLE 1

| | | | Volume ratio of |
|---|---|---|---|
| | | | reaction spaces |
| | Reaction space volume (m³) | | (Gas phase reactor/ |
| Section | Loop reactor | Gas phase reactor | Loop reactor) |
| Example 1 | 72 | 96 | 1.33 |
| Example 2 | 72 | 144 | 2.00 |
| Example 3 | 70 | 84 | 1.20 |
| Comparative | 72 | 44 | 0.61 |
| Example 1 | | | |
| Comparative | 174 | 190 | 1.09 |
| Example 2 | | | |

Properties of the finally obtained polyolefins are shown in Table 2 below.

EPR content means XS content measured by using a Crystex (manufactured by Polymer Char). According to ASTM instrument D1238, MI was measured in the temperature of 230° C. and the weight of 2.16 kg. I-zod was measured by setting a sample made from the molded polyolefin to the thickness of 3.2 mm and by measuring the injected sample at each temperature (23° C. and −20° C.) according to ASTM D256. According to ASTM D648, bending strength was measured by an injected sample.

TABLE 2

| | EPR | | | | Bending |
|---|---|---|---|---|---|
| | content | MI | I-zod | I-zod | strength |
| Section | (%) | (g/10 min) | (23° C.) | (−20° C.) | (kgf/cm²) |
| Example 1 | 33.6 | 23.1 | 62.4 | 9.7 | 7131 |
| Example 2 | 37.8 | 21.3 | 63.5 | 10.4 | 7482 |
| Example 3 | 31.5 | 24.0 | 61.5 | 9.5 | 7070 |
| Comparative | 17.5 | 33.5 | 6.3 | 3.1 | 11358 |
| Example 1 | | | | | |
| Comparative | 25.1 | 32.1 | 28.2 | 4.5 | 10669 |
| Example 2 | | | | | |

Referring to Tables 1 and 2, it can be confirmed that, when the volume ratio of the gas phase reactor to the reaction space of the loop reactor is 1.20 or more, it is possible to prepare a polyolefin having an ethylene-propylene rubber (EPR) content of 30% or more only by the configuration of the single gas phase reactor.

Therefore, in the polyolefin manufacturing apparatus according to the exemplary embodiments, by adjusting the volume ratio of the gas phase reactor to the reaction space of the loop reactor within the above-described range, it is possible to efficiently produce a polyolefin including high content of ethylene-propylene rubber, in particular, impact polypropylene, only by the configuration of the single gas phase reactor without having a plurality of gas phase reactors.

1. An apparatus for manufacturing a polyolefin comprising:
a loop reactor including a first reaction space; and
a single gas phase reactor including a second reaction space into which a first product produced in the loop reactor is introduced;
wherein a volume ratio of the second reaction space to the first reaction space is 1.2 or more.

2. The apparatus for manufacturing a polyolefin according to claim 1, wherein the loop reactor produces the first product from a slurry including a liquid olefin monomer and a polyolefin in the first reaction space.

3. The apparatus for manufacturing a polyolefin according to claim 1, wherein the loop reactor is a plurality of loop reactors which are connected in series.

4. The apparatus for manufacturing a polyolefin according to claim 1, wherein an operating temperature of the loop reactor is 50 to 100° C.

5. The apparatus for manufacturing a polyolefin according to claim 1, wherein an operating pressure of the loop reactor is 10 to 100 bar.

6. The apparatus for manufacturing a polyolefin according to claim 1, wherein the loop reactor is operated in a hydrogen (H₂) atmosphere at a concentration of 300 to 40,000 ppmv.

7. The apparatus for manufacturing a polyolefin according to claim 1, wherein the gas phase reactor forms a polyolefin including ethylene-propylene rubber in the second reaction space.

8. The apparatus for manufacturing a polyolefin according to claim 1, wherein an operating temperature of the gas phase reactor is 50 to 100° C.

9. The apparatus for manufacturing a polyolefin according to claim 1, wherein an operating pressure of the gas phase reactor is 1 to 60 bar.

10. The apparatus for manufacturing a polyolefin according to claim 1, wherein the polyolefin has an ethylene-propylene rubber (EPR) content of 30% or more.

11. The apparatus for manufacturing a polyolefin according to claim 1, wherein the polyolefin is impact polypropylene (impact PP).
